(19) United States
(12) Patent Application Publication
(10) Pub. No.: US 2025/0253553 A1
(43) Pub. Date: Aug. 7, 2025

(54) HOLDING FRAME FOR A PLUG CONNECTOR

(71) Applicant: Phoenix Contact GmbH & Co. KG, Blomberg (DE)

(72) Inventor: Lukas BRILLO, Höxter (DE)

(21) Appl. No.: 19/044,684

(22) Filed: Feb. 4, 2025

(30) Foreign Application Priority Data
Feb. 5, 2024 (BE) BE2024/5068

(51) Int. Cl. H01R 4/48; H01R 13/516

(52) U.S. Cl. CPC H01R 4/48; H01R 13/516

(57) ABSTRACT

A holding frame for a plug connector for receiving a plurality of contact inserts includes: two side parts opposite one another; two end parts which opposite one another, at least one of the two end parts having a PE terminal having a metal terminal contact and a spring-loaded connection terminal, the spring-loaded connection terminal having a clamping spring and a contact piece, the clamping spring having a clamping leg that forms, together with the contact piece, a clamping site for a PE conductor to be connected, the contact piece being connected to the terminal contact in an electrically conductive manner; and an actuation element movable out of a first position, in which the clamping site is closed, into a second position, in which the clamping site is open, the clamping leg being deflected counter to a spring force thereof by the actuation element.

### CROSS-REFERENCE TO PRIOR APPLICATION

Priority is claimed to Belgian Patent Application No. BE 2024/5068, filed on Feb. 5, 2024, the entire disclosure of which is hereby incorporated by reference herein.

### FIELD

The invention relates to a holding frame for a plug connector for receiving a plurality of contact inserts, comprising two side parts opposite one another and two end parts which are also opposite one another. At least one of the two side parts has a PE terminal.

### BACKGROUND

Holding frames of this kind are used for receiving a plurality of contact inserts which can be inserted into the holding frame and consist of an insulating body having a rectangular cross section in which different contact elements can be arranged. Since the contact inserts can be inserted into the holding frame individually, it is possible to equip a holding frame with different contact inserts depending on the intended use. The holding frame having the contact inserts is thus constructed in a modular manner, so the contact inserts are also referred to as contact insert modules or contact modules. The fully equipped holding frame in which the relevant contact inserts are inserted can be inserted into a housing part of a plug connector and fastened therein, the plug connector being used for fastening to a corresponding mating plug connector.

Various types of holding frames that allow individual contact inserts to be inserted in a modular manner are known from practical use. For instance, for many years there have been holding frames that consist of two hingedly interconnected frame halves, the contact inserts being inserted into corresponding recesses in the two frame halves when the holding frame is in the open state and being held in position when the holding frame is in the closed state. In addition, there are holding frames that have a fixed base frame in which the individual contact inserts are inserted into corresponding recesses in a first step. To hold and fasten the contact inserts in the base frame, a fastening clip is secured to the base frame in a second step. In this case, the fastening clip overlaps projections that are formed on the end faces of the contact inserts and engage in the corresponding recesses in the top edge of the base frame.

DE 10 2015 103 563 A1 discloses a holding frame consisting of a rigid, rectangular base frame having two side parts and two end parts, upwardly open recesses delimited to the side by ridges being formed in the top edge of the side parts. A plurality of resilient tabs separated from one another by slots are fastened to the two side parts, and a cut-out is formed in each of said tabs, the tabs being arranged on the side parts such that the cut-outs in the tabs and the cut-outs in the side parts are aligned with one another. The top edge of each cut-out is delimited by a clip portion on which there is formed an inwardly protruding snap-in lug which protrudes into the relevant recess in a side part such that the latching projection on a contact insert inserted into the holding frame is overlapped by the snap-in lug. In this case, the bottom edge of the latching projection rests on the bottom edge of the recess in the side part, whereas the side edges of the latching projection are held by the ridges that delimit the recess to the side.

The tabs preferably consist of a resilient sheet such that the tabs have corresponding resilient properties allowing the contact inserts to be inserted between two opposite tabs until the latching projections formed on the contact inserts are overlapped by the inwardly protruding snap-in lugs formed on the tabs and are thus secured in the holding frame.

The end parts of this holding frame each have a flange portion on which a PE terminal is formed. The PE terminal has a screw terminal such that a PE conductor can be electrically connected to the terminal contact of the PE terminal by means of the screw terminal. A holding frame formed in this way allows the contact inserts to be fastened in the holding frame simply yet still securely, it also being possible to replace individual contact inserts without difficulty.

DE 10 2019 135 726 A1 discloses a holding frame, on each of the two end parts of which there is provided a PE terminal having a metal terminal contact and a spring-loaded connection terminal. The spring-loaded connection terminal has a V-shaped clamping spring having a clamping leg and a contact piece, the clamping leg forming, together with the contact piece, a clamping site for a PE conductor that is to be connected. The contact piece is blanked out of the end part and bent down such that it projects down perpendicularly from the end part. Since the PE terminal in this holding frame has a spring-loaded connection terminal rather than a screw terminal, a PE conductor can be connected very simply and quickly.

Moreover, a housing part is fastened to each end part of the known holding frame, said housing part consisting of an insulating material and having a conductor insertion opening for inserting the PE conductor that is to be connected, as well as an actuation opening. To intentionally release a connected conductor from the clamping site or the spring-loaded connection terminal, the clamping leg of the clamping spring has to be deflected counter to its spring force. For this purpose, an actuation element that can be shifted out of a first position, in which the clamping site is closed, into a second position, in which the clamping site is open, is arranged in the actuation opening. When the actuation element is in the second position, the clamping leg is deflected counter to its spring force by the actuation element such that a connected conductor can be withdrawn from the spring-loaded connection terminal or a flexible conductor can be inserted into the open clamping site. Arranging the actuation element in the actuation opening makes it possible to ensure that the clamping spring is not damaged when the clamping site is opened, for example caused by the use of an unsuitable actuation tool.

Since the holding frame is provided for being inserted into a housing part of a plug connector and fastened therein, the available installation space for the holding frame and thus also for the PE terminal is limited. When a PE terminal having a spring-loaded connection terminal arranged in a housing is used, it may be that only PE conductors of a smaller cross section can be connected to the spring-loaded connection terminal by comparison with a PE terminal having a screw terminal.

### SUMMARY

In an embodiment, the present invention provides a holding frame for a plug connector for receiving a plurality of contact inserts, comprising: two side parts opposite one another; two end parts which opposite one another, at least one of the two end parts having a PE terminal having a metal terminal contact and a spring-loaded connection terminal, the spring-loaded connection terminal having a clamping spring and a contact piece, the clamping spring having a clamping leg that forms, together with the contact piece, a clamping site for a PE conductor to be connected, the contact piece being connected to the terminal contact in an electrically conductive manner; an actuation element movable out of a first position, in which the clamping site is closed, into a second position, in which the clamping site is open, the clamping leg being deflected counter to a spring force thereof by the actuation element when the actuation element is in the second position; and a U-shaped contact chamber having a U-back, a first U-leg, and a second U-leg, the U-shaped contact chamber being arranged on at least one of the two end parts, the U-back being arranged in parallel with the at least one of the two end parts, the first U-leg forming the contact piece, wherein the clamping spring and the actuation element are arranged at least in part in the contact chamber.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1a is a perspective view of a holding frame, without a connected PE conductor,

FIG. 1b is a perspective view of a holding frame, with a connected PE conductor,

FIG. 2 is a plan view of the holding frame according to FIGS. 1a-1b,

FIG. 3 is a perspective view of the holding frame, with two inserted contact inserts,

FIG. 4a shows a detail of the holding frame according to FIG. 1a, without a connected PE conductor and partly in section,

FIG. 4b shows a detail of the holding frame according to FIG. 1b, with a connected PE conductor and partly in section,

FIG. 5a shows a first perspective view of the actuation element,

FIG. 5b shows a second perspective view of the actuation element,

FIG. 6a shows a first perspective view of a first unit composed of a contact insert, an actuation element, and a clamping spring,

FIG. 6b shows a second perspective view of a first unit composed of a contact insert, an actuation element, and a clamping spring,

FIG. 7a shows a first perspective view of a second unit composed of a contact insert, an actuation element, and a clamping spring,

FIG. 7b shows a second perspective view of a second unit composed of a contact insert, an actuation element, and a clamping spring,

FIG. 8 is a perspective view of the holding frame according to FIG. 1a, without a unit inserted into the receiving cavity, and

FIG. 9 is a plan view of the holding frame according to FIG. 8.

### DETAILED DESCRIPTION

In an embodiment, the present invention provides a holding frame that allows a PE conductor to be connected as simply as possible even when there is little installation space available.

In an embodiment, the present invention provides a holding frame having a U-shaped contact chamber having a U-back, a first U-leg, and a second U-leg is arranged on at least one of the two end parts, the U-back being arranged in parallel with the end part, and the first U-leg forming the contact piece. In this case, the clamping spring of the spring-loaded connection terminal and the actuation element are arranged at least in part in the contact chamber, so the U-shaped contact chamber is also used for receiving the clamping spring and the actuation element. Preferably, the holding frame has a PE terminal on both end parts, such that a corresponding U-shaped contact chamber is then also provided on the two end parts.

In the holding frame according to the invention, the use of a U-shaped contact chamber means it is possible to forgo the use of an additional housing. Thus, the actuation element is arranged not in an actuation opening formed for this purpose in an additional housing but directly in the U-shaped contact chamber. In this case, the actuation element is arranged in the contact chamber such that the actuation element can move between its first position and its second position. When the actuation element is in the first position, in which the clamping leg of the clamping spring is not deflected counter to its spring force, a portion of the actuation element can protrude out of the contact chamber slightly such that the actuation element is then only partly arranged in the contact chamber.

According to a preferred embodiment, the actuation element has a first wall arranged perpendicularly to the U-back of the contact chamber. In this case, the wall of the actuation element, the first U-leg, which forms the contact piece and is opposite the first wall of the actuation element, and one part of the U-back of the contact chamber form an insertion region for a PE conductor that is to be connected. The insertion region is located, when viewed in the insertion direction of the PE conductor that is to be connected, upstream of the contact region in which the clamping site for the PE conductor that is to be connected is arranged.

The actuation element arranged in the contact chamber is thus used not only for opening the clamping site but also for forming the insertion region for a PE conductor that is to be connected. In the holding frame according to the invention, the insertion region into which a PE conductor that is to be connected is inserted is thus formed not by a conductor insertion opening formed in a housing but by parts of the contact chamber and at least a first wall of the actuation element. This means that even with limited installation space, an insertion region having a relatively large cross-sectional area can be made available so that conductors of an accordingly large conductor cross section can be connected.

According to a further preferred embodiment, the actuation element has not only a first wall but also a second wall arranged perpendicularly to the first wall and adjacent to the end part of the holding frame. The insertion region for a PE conductor that is to be connected is then formed by the two walls of the actuation element and by the first U-leg and one part of the U-back of the contact chamber. Since the two walls of the actuation element are arranged perpendicularly to one another, and so too are the U-legs and the U-back, the insertion region is rectangular overall. Forming a second wall on the actuation element adjacent to the end part of the holding frame improves the guidance of the actuation element in the contact chamber when the actuation element is moved out of its first position into its second position or out of its second position into its first position.

To allow the actuation element to be moved out of its first position into its second position in a simple manner, at least one guide element is formed on the actuation element and interlocks with a corresponding guide element in the contact chamber when the actuation element moves between its first position and its second position. Preferably, at least two guide elements are formed on the actuation element and, in a corresponding manner, two corresponding guide elements are also formed in the contact chamber, it being possible to form the guide elements on the actuation element as pegs, for example, and to form the corresponding guide elements in the contact chamber as recesses or grooves. The pegs on the actuation element are then guided in the corresponding recesses or grooves in the contact chamber when the actuation element moves.

Preferably, in this case at least one guide element or peg of the actuation element abuts a stop in the recess in the contact chamber, in both the first position and second position of said actuation element. In addition, a latching projection can be formed in a recess in the contact chamber, the actuation element latching in its second position and/or in its first position by means of said latching projection. The configuration of the guide elements on the actuation element and in the contact chamber can also be swapped such that, for example, guide grooves are formed in the actuation element and corresponding guide pegs are formed in the contact chamber. It is also possible for one guide groove and one guide peg, or a plurality of guide grooves and a plurality of guide pegs, to be formed on the actuation element and on the contact chamber in each case.

According to a further advantageous embodiment, the actuation element has a rib on the side facing the end part, a groove corresponding to said rib being formed in the end part of the holding frame. When the actuation element moves between its first position and its second position, the rib of the actuation element is then guided in the groove in the end part. The formation of the rib on the actuation element and of the groove in the end part of the holding frame is preferably provided in addition to the formation of the above-described guide elements on the actuation element and in the contact chamber.

It was stated above that in the holding frame according to the invention the actuation element has at least one first wall that, together with the first U-leg and one part of the U-back of the contact chamber, forms or delimits the insertion region for a PE conductor that is to be connected. Since a conductor inserted into the insertion region is supposed to be pressed against the first U-leg of the contact chamber, said U-leg forming the contact piece, by the free end of the clamping leg in the contact region arranged downstream of the insertion region in the insertion direction of the PE conductor, the actuation element should not be formed and arranged such that the free end of the clamping leg cannot enter the contact region.

Therefore, according to an embodiment of the invention, a recess is formed in the first wall of the actuation element, through which recess the clamping leg of the clamping spring extends. In the assembled state, therefore, the clamping spring is arranged on both sides of the first wall of the actuation element such that at least the free end of the clamping leg protrudes through the recess in the first wall of the actuation element such that the clamping leg can press an inserted PE conductor against the contact piece at the clamping site.

According to an alternative embodiment, the first wall of the actuation element is split in two such that it has a first part and a second part that are separated from one another by a clearance. In this embodiment, the clamping leg of the clamping spring then extends through the clearance between the two parts of the first wall, the free end of the clamping leg likewise protruding into the region of the clamping site.

A feature common to both embodiments of the first wall of the actuation element is that the part of the wall arranged upstream of the clearance or recess when viewed in the insertion direction of the PE conductor that is to be connected delimits one side of the insertion region for the PE conductor that is to be connected. If the actuation element is moved out of its first position into its second position, the clamping leg of the clamping spring is deflected by the end of the first part of the first wall facing the recess or clearance.

Preferably, a leg spring having a clamping leg and a holding leg interconnected by means of a spring arc is used as the clamping spring. The advantage of a leg spring as a clamping spring is that no additional assembly step is needed to connect a rigid conductor. The end of a rigid conductor can be inserted into the clamping site in a simple manner since the clamping leg is deflected by the end of the rigid conductor during insertion. When the PE conductor that is to be connected is inserted into the clamping site, it is securely held by the clamping-leg end extending obliquely to the insertion direction of the conductor, such as to prevent the conductor from being unintentionally withdrawn from the clamping site.

In this case, the actuation element splits the contact chamber into the insertion region and the contact region, which adjoins it in the insertion direction of the PE conductor that is to be connected, as well as a receiving region, which is formed on the other side of the first wall of the actuation element and in which the holding leg, the spring arc, and one part of the clamping leg of the clamping spring are arranged.

It was mentioned at the outset that the contact piece is connected to the terminal contact of the PE terminal in an electrically conductive manner. In this case, the terminal contact and the contact chamber can be formed as two separate components that are rigidly and electrically conductively interconnected by means of a suitable joining process, for example riveting or welding. Fundamentally, it is also conceivable to have an electrically conductive but releasable connection between the contact chamber and the terminal contact, for example by screwing the terminal contact in a corresponding threaded hole in the contact chamber.

According to a preferred embodiment, however, the contact chamber and the terminal contact are formed in one piece. Preferably, in this case the contact chamber and the terminal element are configured as punched-bent parts, it being possible for the terminal contact in particular to be a contact pin or a contact bush formed by bending or rolling after punching.

As mentioned above, the contact chamber is formed in a U-shape such as to have a U-back and two U-legs that project approximately perpendicularly from the U-back. According to a preferred embodiment, the contact chamber additionally has another portion extending substantially perpendicularly to the insertion direction of a conductor that is to be connected and arranged in the extension of the insertion region or contact region. This portion is preferably bent down from the first U-leg, which forms the contact piece of the spring-loaded connection terminal. The bent portion then forms a plugging guard for a PE conductor that is to be connected, thereby preventing a conductor that is to be connected from being able to be inserted too far into the connection site.

The contact chamber can be fastened to the corresponding end part by forming corresponding latch elements on the end part and on the contact chamber. According to a preferred embodiment of the invention, however, a receiving cavity for receiving the pre-assembled unit composed of the contact chamber, the clamping spring, and the actuation element is formed at the end part that has the PE terminal. The advantage of forming a corresponding receiving cavity at an end part, preferably at both end parts, is that the clamping spring and actuation element can be pre-assembled on the contact chamber and then the pre-assembled unit can be inserted into the receiving cavity and preferably latched therein in a simple manner.

To fasten the contact chamber or the pre-assembled unit securely and durably, the receiving cavity preferably has four walls and a substantially rectangular bottom. The four walls thus form a substantially rectangular receiving cavity. In this case, a first wall is formed by the end part of the holding frame. The second wall is arranged in parallel with the end part or first wall, whereas the third and fourth walls are each arranged between the first and the second wall perpendicularly to the first and the second wall. In this case, the internal dimensions of the receiving cavity are adapted to the external dimensions of the contact chamber such that the contact chamber can be inserted into the receiving cavity with little play. In addition, an opening is formed in the bottom of the receiving cavity, through which opening the terminal contact connected to the contact chamber can be passed during insertion into the receiving cavity.

For the contact chamber or the unit composed of the contact chambers, clamping spring, and actuation element to be securely and fixedly arranged in the receiving cavity, the contact chamber has at least one latch element that latches to a corresponding counterpart latch element on a wall of the receiving cavity. In particular, snap-in lugs and snap-in recesses can be provided as the latch element and counterpart latch element. Preferably, at least one spring-loaded snap-in lug that latches into a corresponding snap-in recess in the second wall of the receiving cavity is formed on the U-back of the contact chamber.

When the aim is to secure the contact chamber or pre-assembled unit in the receiving cavity particularly securely and durably, then a deformation region is formed on at least one wall, preferably the second wall of the receiving cavity, at its end remote from the bottom. In this case, the deformation region is intended for form-fittingly connecting to the contact chamber, for which purpose the deformation region can be reshaped by a stamping process once the unit has been inserted into the receiving cavity.

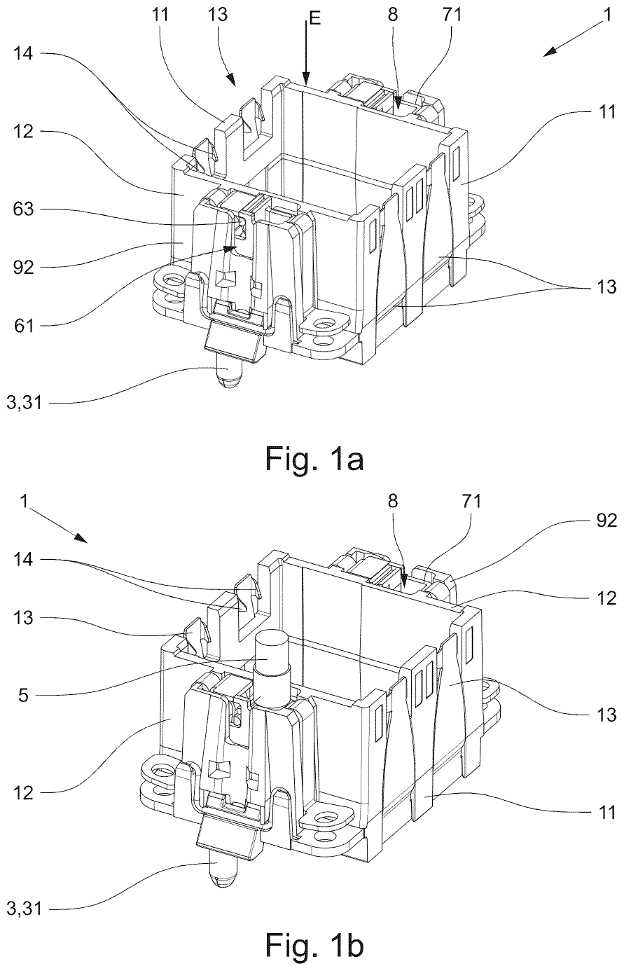

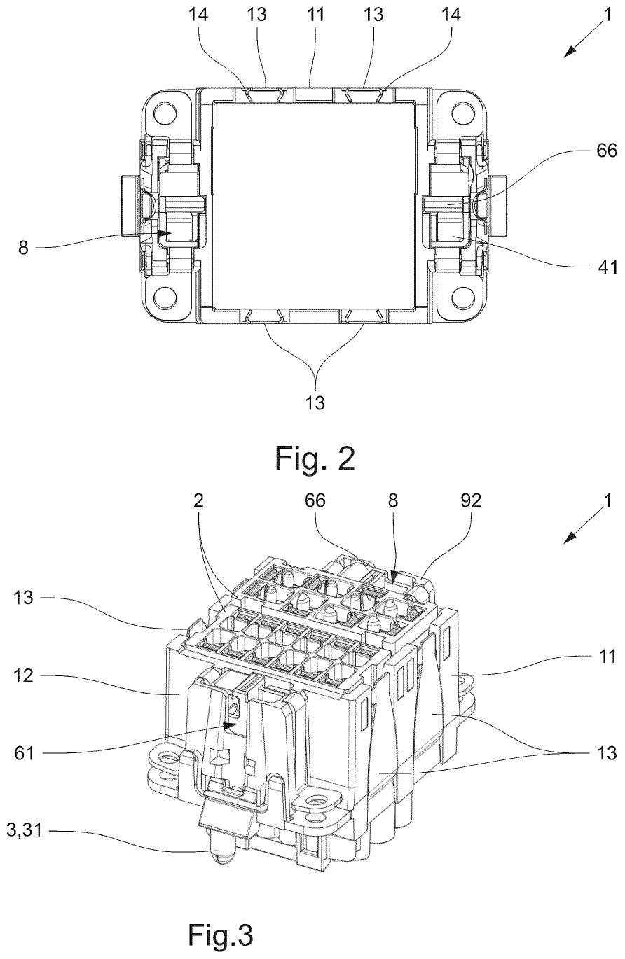

FIGS. 1a-1b show perspective views, obliquely from above, of a preferred embodiment example of a holding frame 1 according to the invention, where “above” refers to the side of the holding frame 1 from which a contact insert 2 is inserted into the holding frame 1 in the insertion direction E, with FIG. 1a showing a holding frame without a connected PE conductor and FIG. 1b showing a holding frame with a connected PE conductor. FIG. 2 shows the holding frame 1 from above, and FIG. 3 is a perspective view of the holding frame 1 like FIG. 1, with two contact inserts 2 inserted. The holding frame 1 can also be of such a length as to be suitable for receiving a different number of contact inserts 2, for example such that it can receive four, five, six, or more contact inserts 2.

The holding frame 1 has a rectangular basic shape and consists of two side parts 11 opposite one another and two end parts 12 which are also opposite one another, the end parts 12 being arranged perpendicularly to the side parts 11. In the embodiment example shown, two resilient tabs 13 are fastened to each of the two side parts 11, the tabs 13 being opposite the side parts 11 in pairs. The tabs 13 are used for fastening contact inserts 2 inserted into the holding frame 1. For this purpose, the contact inserts 2 each have a latching projection on their end faces, the latching projections each being overlapped by holding lugs 14 in the inserted state, said holding lugs being bent down inwardly on the tabs 13. However, the invention is not limited to the embodiment of the tabs 13 as shown. By way of example, the tabs can also be formed like the tabs shown and described in DE 10 2015 103 563 A1 or DE 10 2019 135 726 A1.

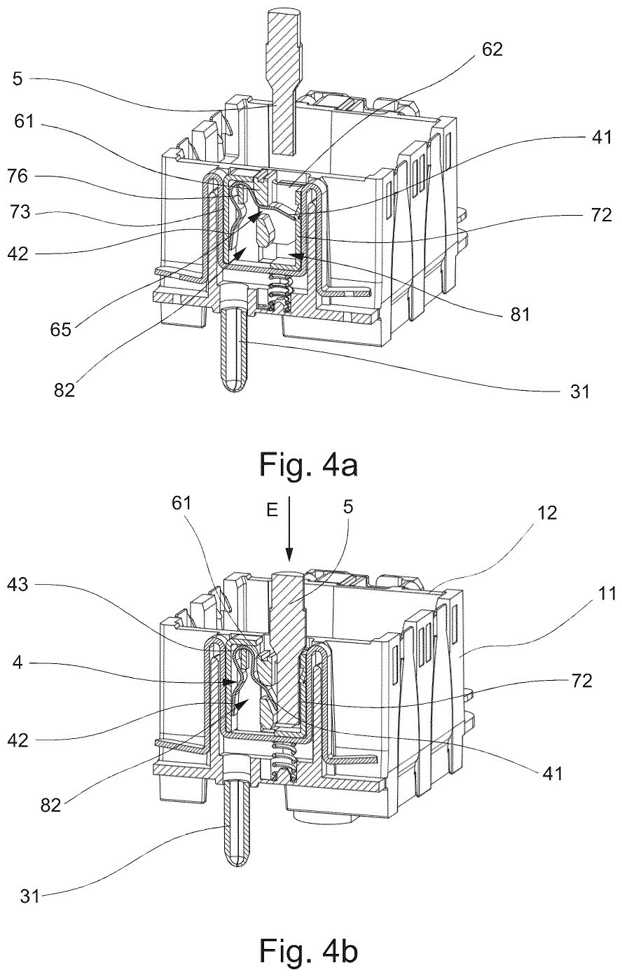

The holding frame 1 shown in the drawings has a PE terminal on each of its two end parts 12, each of said PE terminals being formed by a terminal contact 3 and a spring-loaded connection terminal. The terminal contact 3 is formed as a contact pin 31 on one end part 12 and as a contact bush 32 on the other end part 12. The spring-loaded connection terminal is formed by a clamping spring 4 and a contact piece. As can be seen from the sectional views according to FIGS. 4a-4b, the V-shaped clamping spring 4 has a clamping leg 41, a holding leg 42, and a spring arc 43, which is arranged between the clamping leg 41 and the holding leg 42. Together with the contact piece, the clamping leg 41 forms a clamping site for a PE conductor 5 that is to be connected, such that the stripped end of the PE conductor 5 is pressed against the contact piece by the end of the clamping leg 41 when in the connected state.

To release a connected PE conductor 5 from the clamping site, the clamping leg 41 of the clamping spring 4 has to be deflected counter to its spring force. For this purpose, an actuation element 6 is provided, which can be shifted out of a first position (FIG. 4a), in which the clamping site is closed, into a second position (FIG. 4b), in which the clamping leg 41 is deflected. In the holding frame 1, a U-shaped contact chamber 7 in which the clamping spring 4 and the actuation element 6 are arranged is fastened to each of the two end parts 12.

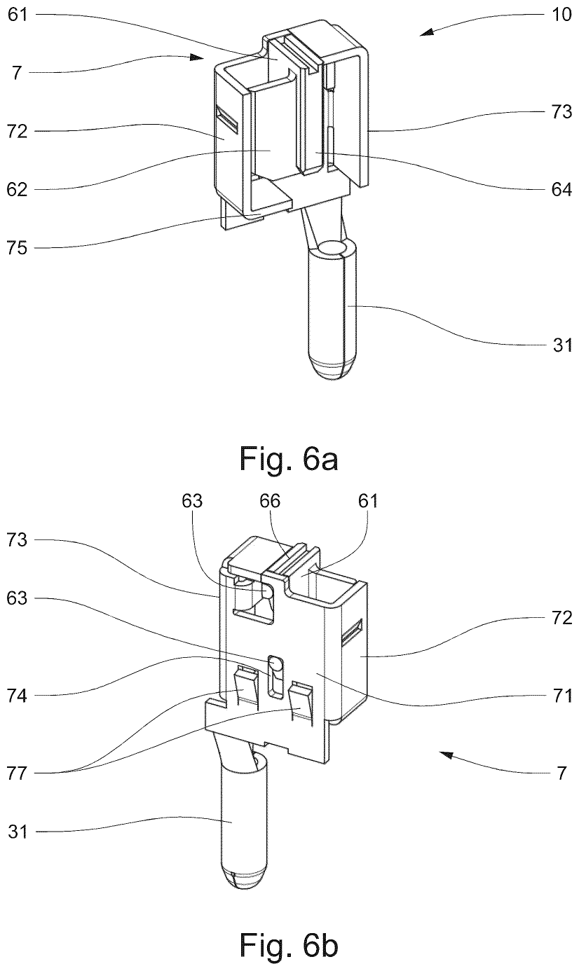

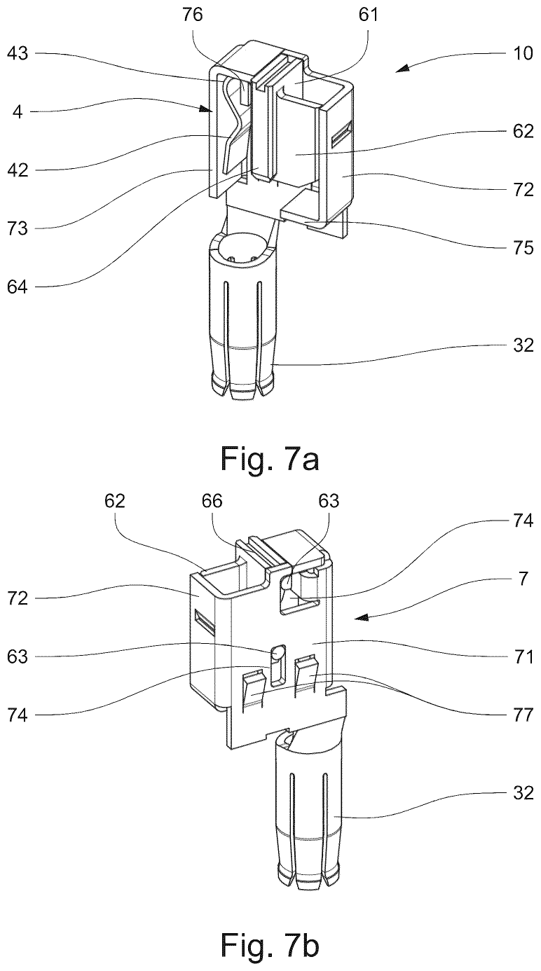

The U-shaped contact chamber 7, which can be seen in particular in FIGS. 6a-6b and 7a-7b, has a U-back 71, a first U-leg 72, and a second U-leg 73. The U-back 71 is arranged in parallel with the end part 12, whereas the two U-legs 72, 73 are arranged perpendicularly to the U-back 71 and thus also perpendicularly to the end part 12. It can be seen from the sectional views according to FIGS. 4a-4b that the contact piece, which forms the spring-loaded connection terminal together with the clamping leg 41 of the clamping spring 4, is formed by the first U-leg 72. A connected PE conductor 5 is thus pressed against the first U-leg 72 by the free end of the clamping leg 41 such that the PE conductor 5 is electrically connected to the contact chamber 7. Since the contact chamber 7 is formed in one piece with the terminal contact 3, a connected PE conductor 5 is thus electrically connected to the terminal contact 3.

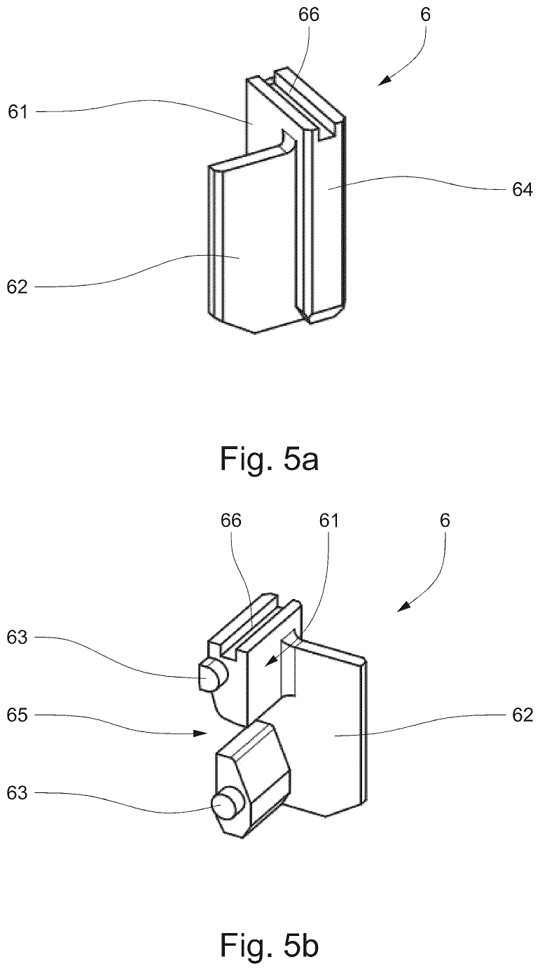

As can be seen in particular from the separate views of the actuation element 6 according to FIGS. 5a-5b, the actuation element 6 has a first wall 61 and a second wall 62 arranged perpendicularly to one another. The first wall 61 of the actuation element 6 is split in two such that a clearance 65 is formed between the two parts of the wall 61, through which clearance the clamping leg 41 of the clamping spring 4 extends.

Arranging the actuation element 6 in the contact chamber 7 creates an insertion region 8 for the PE conductor 5 that is to be connected, said insertion region being delimited by the two walls 61, 62 of the actuation element 6 and by the first U-leg 72 and one part of the U-back 71 of the contact chamber 7. The actuation element 6 is thus used not only for actuating the clamping leg 41 of the clamping spring 4 but also for splitting the contact chamber 7 into an insertion region 8 and the contact region 81, which adjoins it in the insertion direction E of the PE conductor 5 that is to be connected, as well as a receiving region 82, which is formed on the other side of the first wall 61 of the actuation element 6 and in which the holding leg 42, the spring arc 43, and one part of the clamping leg 41 of the clamping spring 4 are arranged. To hold the clamping spring 4, a bearing portion 76 extending perpendicularly to the U-back 71 is formed on the U-back 71 of the contact chamber 7. In this case, the holding portion 76 is used for positioning and holding the spring arc 43 of the clamping spring 4.

To guide the actuation element 6 as it moves out of the first position into the second position, or out of the second position into the first position, there are arranged on the actuation element 6 two guide elements 63, which are formed as pegs and engage in corresponding guide elements 74 in the contact chamber 7, as can be seen from FIGS. 6b and 7b. In this case, the pegs 63 are arranged on an end face of the first wall 61 of the actuation element 6 such that the guide elements 74 formed as recesses are accordingly formed in the U-back 71 of the contact chamber 7. In addition, the actuation element 6 has a rib 64 as a further guide element on the end face of the first wall 61 opposite the pegs 63. Since the rib 64 is not opposite the U-back 71 of the contact chamber 7 but opposite the end part 12 of the holding frame 1, a groove 15 corresponding to the rib 64 is formed in the end part 12, the rib 64 being guided in this groove when the actuation element 6 moves between its first position and its second position.

To shift the actuation element 6 out of its first position into its second position more easily, an actuation portion 66 is formed in the first wall 61 of the actuation element 6, in which actuation portion the tip of a screwdriver, for example, can be inserted. As can be seen from FIGS. 1 and 2, the actuation portion 66 is arranged such as to be accessible from the same direction from which a PE conductor 5 to be connected is inserted into the insertion region 8.

FIGS. 6a-6b and 7a-7b show different perspective views of a pre-assembled unit 10 consisting of the contact chamber 7, the clamping spring 4, and the actuation element 6. In the unit 10 shown in FIGS. 6a-6b, a pin contact 31 is provided as a terminal contact, whereas in the unit 10 shown in FIGS. 7a-7b, the terminal contact is formed as a bush contact 32. Both the pin contact 31 and the bush contact 32 are formed in one piece with the contact chamber 7, i.e., are arranged adjoining the lower portion of the U-back 71 that is at the bottom in the insertion direction E. The contact chamber 7 having the contact pin 31 or contact bush 32 can be produced in a simple manner as a punched-bent part.

To prevent a PE conductor 5 from being inserted too far into the contact chamber 7, a portion 75 on the first U-leg 72 is bent down such as to be arranged perpendicularly to the insertion direction E of the PE conductor 5 that is to be connected and in the extension of the insertion region 8 below the contact region 81. The portion 75 is thus used as a plugging guard for a PE conductor 5 that is to be connected.

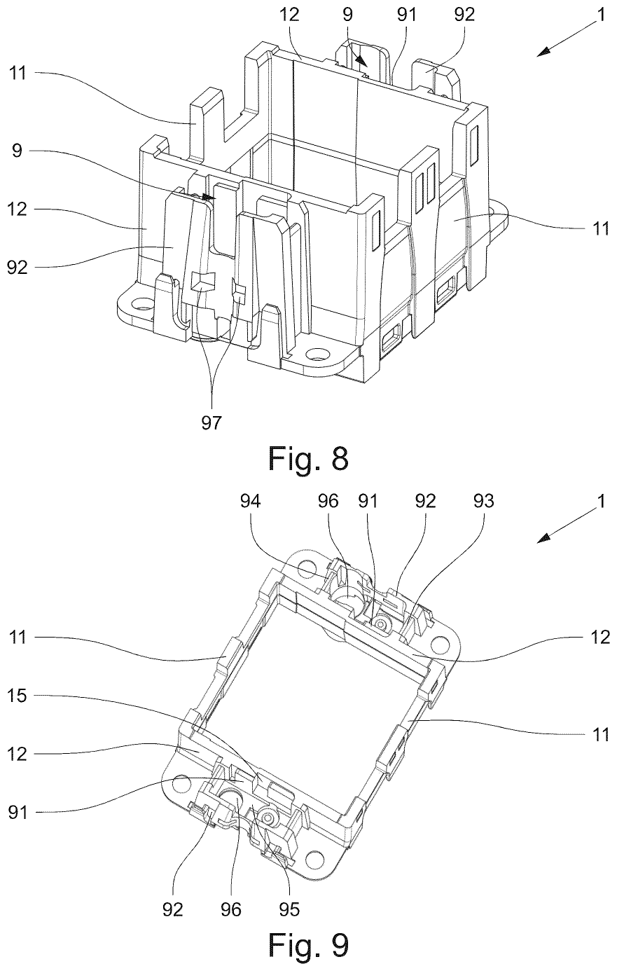

To fasten the contact chamber 7 or unit 10 to the holding frame 1, a receiving cavity 9 is formed at each of the two end parts 12. The rectangular receiving cavity 9 has four walls 91-94 and a rectangular bottom 95. It can be seen from the two views according to FIGS. 8 and 9, which show the holding frame 1 without a unit 10 and without tabs 13, that the first wall 91 of the receiving cavity 9 is formed in each case by an end part 12 of the holding frame 1. To allow a unit 10 having a terminal contact 3 formed in one piece with the contact chamber 7 to be inserted into the receiving cavity 9, a corresponding opening 96 is formed in the bottom 95 of the receiving cavity 9, through which opening the pin contact 31 or bush contact 32 can protrude.

To secure the unit 10 or contact chamber 7 in the receiving cavity 9, two spring-loaded latch elements 77 and counterpart latch elements 97, formed as openings in the second wall 92 of the receiving cavity 9 opposite the end part 12, are formed on the U-back 71 of the contact chamber 7. When the unit 10 is inserted into the receiving cavity 9, the latch elements 77 latch into the corresponding counterpart latch elements 97 such that the contact chamber 7 or unit 10 is securely held in the receiving cavity 9.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Reference Signs

| | | | |
|---|---|---|---|
| 1. | Holding frame | 72. | U-leg (contact piece) |
| 10. | Unit | 73. | U-leg |
| 11. | Side part | 74. | Recess (guide element) |
| 12. | End part | 75. | Portion (plugging guard) |
| 13. | Tab | 76. | Holding portion |
| 14. | Holding lug | 77. | Latch element |
| 15. | Groove | | |
| 2. | Contact insert | 8. | Insertion region |
| 3. | Terminal contact | 81. | Contact region |
| 31. | Pin contact | 82. | Receiving region |
| 32. | Bush contact | | |
| 4. | Clamping spring | 9. | Receiving cavity |
| 41. | Clamping leg | 91-94. | Walls |
| 42. | Holding leg | 95. | Bottom |
| 43. | Spring arc | 96. | Opening |
| 5. | PE conductor | 97. | Counterpart latch element |
| 6. | Actuation element | | |
| 61. | First wall | E | Insertion direction |
| 62. | Second wall | | |
| 63. | Peg (guide element) | | |
| 64. | Rib | | |
| 65. | Clearance | | |
| 66. | Actuation portion | | |
| 7. | Contact chamber | | |
| 71. | U-back | | |

1: A holding frame for a plug connector for receiving a plurality of contact inserts, comprising:
two side parts opposite one another;
two end parts which opposite one another, at least one of the two end parts having a PE terminal having a metal terminal contact and a spring loaded connection terminal, the spring loaded connection terminal having a clamping spring and a contact piece, the clamping spring having a clamping leg that forms, together with the contact piece, a clamping site for a PE conductor to be connected, the contact piece being connected to the terminal contact in an electrically conductive manner;
an actuation element be movable out of a first position, in which the clamping site is closed, into a second position, in which the clamping site is open, the clamping leg being deflected counter to its a spring force thereof by the actuation element when the actuation element is in the second position; and
a U-shaped contact chamber having a U-back, a first U-leg, and a second U-leg, the U-shaped contact chamber being arranged on at least one of the two end parts, the U-back being arranged in parallel with the at least one of the two end parts, the first U-leg forming the contact piece,
wherein the clamping spring and the actuation element are arranged at least in part in the contact chamber.

2: The holding frame of claim 1, wherein the actuation element has a first wall arranged perpendicularly to the U-back of the contact chamber, and
wherein the first wall of the actuation element, the first U-leg forming the contact piece, and one part of the U-back 1 of the contact chamber form an insertion region for the PE conductor to be connected.

3: The holding frame of claim 2, wherein the actuation element has a second wall arranged perpendicularly to the first wall and adjacent to the end part of the holding frame (1 such that the insertion region for the PE conductor that is to be connected is formed by the first wall and the second wall of the actuation element and by the first U-leg and one part of the U-back of the contact chamber.

4: The holding frame of claim 1, wherein at least one guide element is formed on the actuation element and at least one corresponding guide element is formed in the contact chamber, and
wherein the at least one guide element on the actuation element and the at least one corresponding guide element in the contact chamber are interlocking such that the actuation element is guided in the contact chamber upon movement between the first position and the second position.

5: The holding frame of claim 1, wherein the actuation element has a rib on a side facing the end part, and a corresponding groove in the end part of the holding frame, the rib being guidable in this groove upon movement of the actuation element between the first position and the second position.

6: The holding frame of claim 2, wherein either the first wall of the actuation element is split in two, or a recess is formed in the first wall of the actuation element, and
wherein the clamping leg of the clamping spring extends through a clearance between two parts of the first wall or through the recess in the first wall.

7: The holding frame of claim 2, wherein the first wall of the actuation element has an actuation portion configured for insertion of a tool.

8: The holding frame of claim 1, wherein the contact chamber and the terminal contact are formed in one piece.

9: The holding frame of claim 1, wherein, on the first U-leg, one portion extending substantially perpendicularly to an insertion direction of the PE conductor to be connected is bent down.

10: The holding frame of claim 1, wherein a holding portion for the clamping spring is formed on the U-back.

11: The holding frame of claim 1, wherein a receiving cavity configured to receive a pre-assembled unit is formed at least on the end part that has the PE terminal, the pre assembled unit comprising the contact chamber, the clamping spring, and the actuation element.

12: The holding frame of claim 11, wherein the receiving cavity has four walls and a substantially rectangular bottom,
wherein the first wall is formed by the end part, and
wherein the substantially rectangular bottom has an opening through which the terminal contact protrudes.

13: The holding frame of claim 11, wherein the contact chamber has at least one latch element configured to latch to a corresponding counterpart latch element formed on one wall of the receiving cavity.

14: The holding frame of claim 11, wherein at least one wall of the receiving cavity has a deformation region at an end thereof remote from the substantially rectangular bottom, the deformation region being configured to establish a form fitting connection to the contact chamber.

15: The holding frame of claim 1, wherein at least one resilient tab is provided on each side part of the two side parts, and
wherein the tabs each have a latch configured to secure a latching projection of a contact insert inserted into the holding frame.
